(19) United States
(12) Patent Application Publication
(10) Pub. No.: US 2003/0017346 A1
(43) Pub. Date: Jan. 23, 2003

(54) Method for enhancing strength and durability of an adhesive joint of ion-doped glass components

(76) Inventors: William Thomas Moore, Ottawa (CA); Mirza Cevro, Ottawa (CA); Lucie Robitaille, Aylmer (CA); Jing Li, Ottawa (CA); James Arthur O'Neill, Ottawa (CA); Janet Turner, Nepean (CA); Graham Carlow, Ottawa (CA); Robert Bruce, Stittsville (CA)

Correspondence Address: Juliusz Szereszewski, Registered Patent Agent, JDS Uniphase Corporation, 570 West Hunt Club Road, Nepean (Ottawa), ON, K2G 5W8, CA

(21) Appl. No.: 10/196,141

(22) Filed: Jul. 17, 2002

Related U.S. Application Data
(60) Provisional application No. 60/306,143, filed on Jul. 19, 2001.

(51) Int. Cl. B32B 17/00

(52) U.S. Cl. 428/432; 428/433; 428/446; 428/450; 428/471; 428/162

(57) ABSTRACT

The strength and durability of an adhesive joint between two glass components or a glass component and another element can be improved by preventing or retarding migration of ions present in glass to the glass-adhesive interface. This can be effected by coating the glass surface at the joint with a submicron layer of silicon dioxide (SiO₂), aluminum oxide (Al₂O₃), a multi-layer coating containing silicon dioxide or another ion-migration retarding material.

This application claims priority from U.S. Provisional Application No. 60/306,143 filed Jul. 19, 2001.

### FIELD OF THE INVENTION

This invention relates to ion-doped glass components, and specifically to methods of adhesive bonding of glass components to other, similar or different components using adhesives and binders, e.g. epoxy adhesives.

### BACKGROUND OF THE INVENTION

Optical assemblies often require joints between optical elements made of optically transparent materials. An example of such assembly is a combination of a lens with a filter attached to one side of the lens, or two lenses with a filter disposed between them and non-releasably secured to both lenses.

Commercially available epoxy adhesives of an “optical grade” are commonly used for joining optical elements and generally provide satisfactory joints and proper optical performance of the assembly.

However, certain optical glasses contain free ions and are not immune to ion migration in an aqueous environment. It has been found that in a humid environment, the free ions in the glass can migrate to the interface between the glass and the adhesive. This phenomenon may often give rise to a weakening of the adhesive joint to a degree where the joint deteriorates and fails.

It is desirable to enhance the strength and durability of an adhesive joint between two optical elements or an optical element and another element, wherein at least one of the elements is an ion-doped glass exhibiting some water-solubility or susceptible to ion migration therein.

### SUMMARY OF THE INVENTION

According to one aspect of the invention, there is provided a method of enhancing adhesion between the glass surface of a component and an adhesive, wherein a bonding interface is defined between the adhesive and the class surface, the method comprising the step of providing a layer of an ion-migration retarding material disposed between the glass surface and the adhesive, the layer being non-releasably attached to at least the glass surface, or to the glass surface and the adhesive.

It has been found that a layer of silicon dioxide (SiO₂), aluminum oxide (Al₂O₃) or a multi-layer coating containing a silicon dioxide layer performs satisfactorily to enhance the strength and durability of a joint between a glass element and an organic adhesive. Typically, the adhesive is an optical epoxy adhesive but it is conceivable to use the invention with other adhesives or binders, for example acrylate, acrylate-urethane and other organic adhesives, hybrid adhesives (e.g. polysiloxane-based adhesives) or inorganic adhesives e.g. solders. Within the scope of the invention, metallic solders fall under the definition “inorganic adhesive”.

The ion-migrating retarding material should be selected to have mechanical properties compatible with the properties of the glass elements joined together. If optical components are to be joined, it might also be required to have compatible optical properties with the optical elements, notably the refractive index.

In accordance with another aspect of the invention, there is provided an adhesive joint between a glass surface and another material, the joint comprising an adhesive and a layer of an ion-migration retarding material disposed between, and non-releasably attached to the glass surface or to both the glass surface and the organic adhesive.

The adhesive may be any suitable adhesive, for example one used in the optical and fiber-optic industry, either transparent or opaque. In an embodiment of the invention, the glass parts are made of commercially available optical glasses, the adhesive is an epoxy adhesive typically used in the fiberoptics industry and the retarding material is silicon dioxide (SiO₂), aluminum oxide (Al₂O₃) or a multi-layer coating containing a silicon dioxide layer. The thickness of the retarding material layers may be of the order of one micron (1 μm) or less, down to about 300 microns or possibly less.

In accordance with another aspect of the invention, there is provided a method of inhibiting the ion migration and formation of crystals at the surface of an ion-doped glass element, apart from an adhesive connection of the component to another element. The method comprises the deposition of a layer of an ion-migration retarding material on the surface of the optical element. The material is preferably silicon dioxide (SiO₂), aluminum oxide (Al₂O₃) or a multi-layer coating material containing a silicon dioxide layer.

The invention may be used to glue, solder or otherwise attach optical elements to non-transparent elements, e.g. made of other materials than glass.

### BRIEF DESCRIPTION OF THE DRAWINGS

In the drawings,

FIG. 1 is a comparison of various coatings on SLC lenses for ‘As-Built’ and aged samples (3 days at 105° C./100%RH); type 1 filter substrates were uncoated;

FIG. 2 is a comparison of various coatings on SLC lenses for ‘As-Built’ and aged samples (3 days at 105° C./100%RH); type 2 filter substrates were uncoated;

FIG. 3 illustrates a comparison of 335 nm and 530 nm thick SiO₂ coatings with and without plasma cleaning built into centerpieces using uncoated type 1 filter substrates; joint strength is shown before and after aging (3 days at 105° C./100%RH);

FIG. 4 illustrates a comparison of 335 nm and 530 nm thick SiO₂ coatings with and without plasma a cleaning built into centerpieces using coated type 1 filter substrates; joint strength is shown before and after aging (3 days at 105° C./100%RH);

FIG. 5 illustrates a comparison of 335 nm and 530 nm thick SiO₂ coatings with and without plasma cleaning built into centerpieces using uncoated type 2 filter substrates; joint strength is shown before and after aging (3 days at 105° C./100%RH);

FIG. 6 illustrates a comparison of 335 nm and 530 nm thick SiO₂ coatings with and without plasma cleaning built into centerpieces using coated type 2 filter substrates; joint strength is shown before and after aging (3 days at 105° C./100%RH);

FIG. 7 shows the effect of a 530 nm thick SiO₂ coating layer on the joint strength of centerpieces built with various combinations of coated and uncoated SLC lenses and type 1 & 2 filter substrates; joint strength is shown before and after aging (3 days at 105° C./100%RH and 1000 hours at 75° C./90%RH);

FIG. 8 shows the joint strength over time at 85° C./85%RH for centerpieces built with various combinations of SiO₂ coated (335 nm thick layers) and uncoated SLC lenses and type 2 filter substrates (with plasma cleaning); and

FIG. 9 shows the joint strength over time at 85° C./85%RH for centerpieces built with various combinations of SiO₂ coated (335 nm thick layers) and uncoated SLC lenses and type 2 filter substrates (without plasma cleaning).

### DETAILED DESCRIPTION OF THE INVENTION

Experimental

In the actual experiments conducted to validate the invention, the following coatings were examined:

Al₂O₃ coatings (0.5 and 2.0 micron thick)

silicon dioxide (SiO₂) coatings (335 and 530 nm thick)

4 layer coating composed of alternating Nb₂O₅ and SiO₂ layers, each layer in the order of one micron or less

Silicon, aluminum or niobium oxides were deposited onto a substrate using an ion-assisted sputtering process.

Commercial GRIN (graded index) lenses and glass substrates were used as ion-doped glass optical elements. Two types of glass substrates were used and are referred to herein as ‘type 1’ and ‘type 2’. These substrates are made of glass doped with ions such as sodium, potassium, etc.

Sample Preparation for all Coating Groups

Following the preparation of the ion-migration “barrier” coatings, the optical elements were attached with adhesives into centerpiece assemblies. A centerpiece assembly consists of an optical filter sandwiched between two GRIN lenses. To eliminate failure by filter delamination, which are not of any interest in this study, the centerpieces were built with glass substrates only (no filter coating on the backside).

Plasma cleaning (5 minutes, 400 W, ratio of O₂ to Ar 90:10) was used on the lenses and filter substrates prior to building the centerpieces, unless otherwise stated.

Most of the coating groups were tested in centerpieces built with both type 1 and 2 filter substrates (no filter coating), and using coated and uncoated filter substrates.

Aging of the Centerpieces

After joining with adhesives, the assemblies with or without the “barrier” coatings were aged in various damp heat conditions: 3 days at 105° C./100%RH, up to 1000 hours at 75° C./90%RH and up to 2000 hours at 85° C./85%RH. The ‘as-built’ groups consisted of a sample size of 8 centerpieces, and the aged sample groups consisted of 12 centerpieces per aging conditions, unless otherwise stated.

Joint Strength Determination

Following the aging, all centerpieces were mechanically tested, as described below. A load was applied on the adhesive joints and the force required to break the joints was monitored. ‘As-built’ samples and aged samples were prepared for comparison purposes to uncoated controls.

All of the joints were broken in an Instron test stand using a 10 pound load cell and the centerpiece fixture holder, by the same operator. Every centerpiece was oriented in the same direction in the holder. A dot was placed on the 1st step lens (lens on which the filter substrate is first attached) and an ‘x’ placed on the 2nd step lens, such that they were inline with one another and the push rod. This marking scheme is to assist in the failure analysis, so that the direction of the force applied to the centerpiece by the push rod is known. All centerpieces were broken on the same day when removed from the humidity chamber.

Failure Analysis on Centerpieces

After joint strength testing of the centerpieces, failure analysis was conducted on the various groups. Not all centerpieces were characterized. The strongest, weakest and some “average strength” samples were inspected, characterized and photographed at 27.5×magnification, using differential interference contrast view. ‘As-built’ samples had two “average strength” samples inspected and the aged samples had three “average strength” samples inspected. These centerpieces were characterized for their mode of failure, especially adhesive failures, and observance of crystal formation (viewed at 550×magnification).

Results

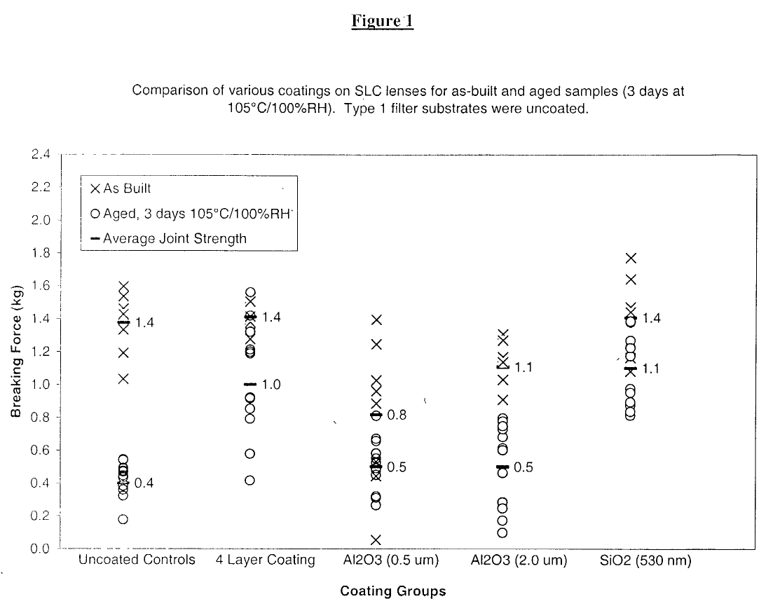

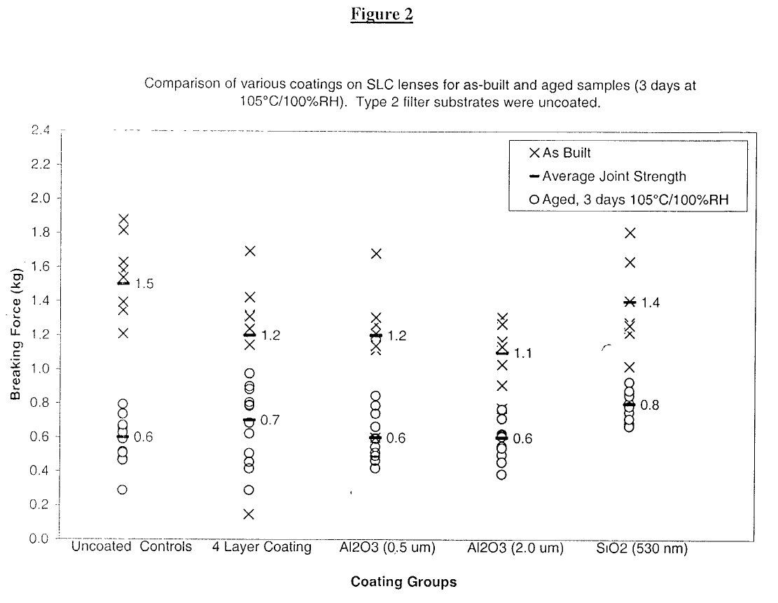

1) Tests on Various Lens Coatings (FIGS. 1 and 2)

In this first series of experiments, different coatings were tested for their efficiency as ion-migrating “barriers”. The coatings investigated were silicon dioxide (SiO₂, 530 nm thick), aluminum oxide (Al₂O₃), and a 4 layer coating composed of alternating Nb₂O₅ and SiO₂ layers, as described in paragraph [014] above.

Plasma cleaning was used just prior to assembly of the centerpieces. The sample groups had only their lenses coated. Uncoated type 1 (FIG. 1) and type 2 (FIG. 2) filter substrates were used. Control groups consisted of centerpieces built using uncoated lenses and uncoated type 1 and 2 filter substrates. Sample groups were built and tested for ‘As-Built’ (non-aged) and aged (3 days at 105° C./100%RH).

Crystal formation was only observed on uncoated lenses and filter substrates.

Statistical analysis (t-test assuming unequal variances; 95% confidence interval¹) showed significant higher joint strength in aged centerpieces built with the 4 layer coating and the single-layer SiO₂ coating compared to centerpieces built with uncoated lenses and filter substrates. ¹ Due to small sample size (12 centerpieces per group), the statistical analysis should not be taken to be absolute, but to be used as a tool for monitoring large changes between groups.

Statistical analysis did not show any significant differences between the Al₂O₃ coatings and uncoated control samples (for aged samples).

The coating group which achieved the highest average center piece joint strength after aging in damp heat conditions was the single-layer SiO₂ coating. The superior centerpiece joint strength of the SiO₂-coated groups vs. the uncoated controls can be explained by the failure analysis results, which indicated no signs of crystal formation, no incidents of adhesive failures and only small amounts of lens coating delamination.

The 4-layer coating groups showed some improvement in centerpiece joint strength after aging, but still fell short when compared to silicon dioxide coated groups.

The difference in aged centerpiece joint strength between the 4-layer coating groups and the SiO₂ coating groups can be explained by a higher incidence of coating delamination observed in the 4 layer coating groups, as opposed to the small amount of SiO₂ coating, delamination off of the lenses.

The failure mode analysis suggests that the cause of the poor centerpiece joint strength in the Al₂O₃ coating groups is an adhesion problem between the coating and the adhesive as based on the high incidence of adhesive failures between the adhesive and coated lenses. The absence of crystals on the surface of aged aluminum oxide coated lenses demonstrates that Al₂O₃ is an effective ion-retarding “barrier”. The adhesion between aluminum oxide and the adhesive used in this work would however need to be improved to make the combination satisfactory.

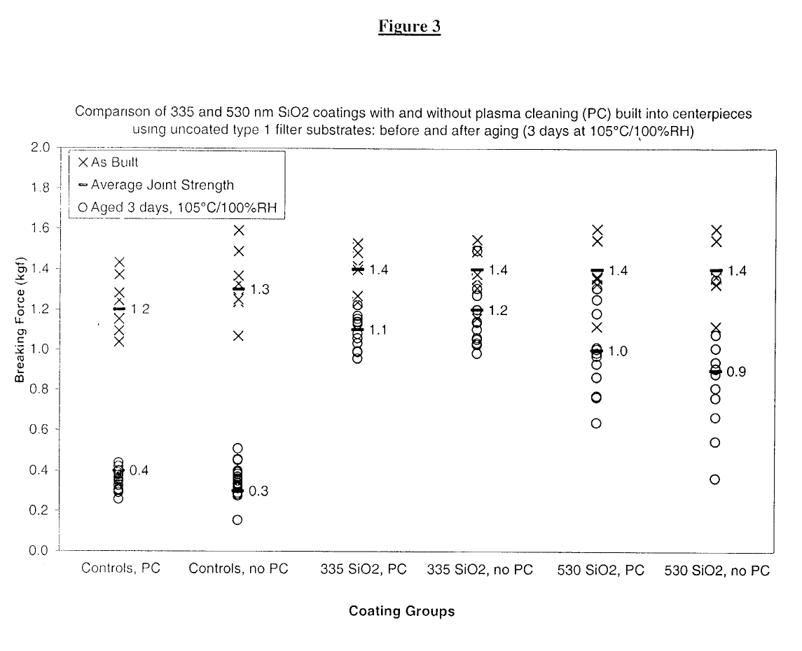

2) Silicon Dioxide Coatings Tested on Centerpieces Using Various Parameters (FIGS. 3 to 6)

In this test, various characteristics of the SiO₂ coatings were varied to assess the effect of these parameters on the efficiency of the ion-migration “barriers”. Sputter coated 335 nm and 530 nm thick silicon dioxide coatings on SLC lenses were tested using various following parameters:

with and without plasma cleaning

with uncoated and coated filter substrates

using type 1 and type 2 filter substrates

Sample groups were built and tested for ‘As-built’ (non-aged) and aged (3 days at 105° C./100%RH).

It is clear from FIGS. 3 to 6 that both the 335 nm and 530 nm SiO₂ coatings, under any of the tested conditions give statistically (t-test assuming unequal variances; 95% confidence interval²) significant higher joint strength results after aging when compared to the uncoated control groups. ² Due to small sample size (12 centerpieces per group), the statistical analysis should not be taken to be absolute, but to be used as a tool for monitoring large changes between groups.

However, similar statistical analysis² did not show systematic differences in aged centerpiece joint strength between the 335 nm and 530 nm coating thicknesses. The 335 nm and 530 nm coatings, with or without plasma cleaning, generally do not show a significant difference in joint strength after aging. ² Due to small sample size (12 centerpieces per group), the statistical analysis should not be taken to be absolute, but to be used as a tool for monitoring large changes between groups.

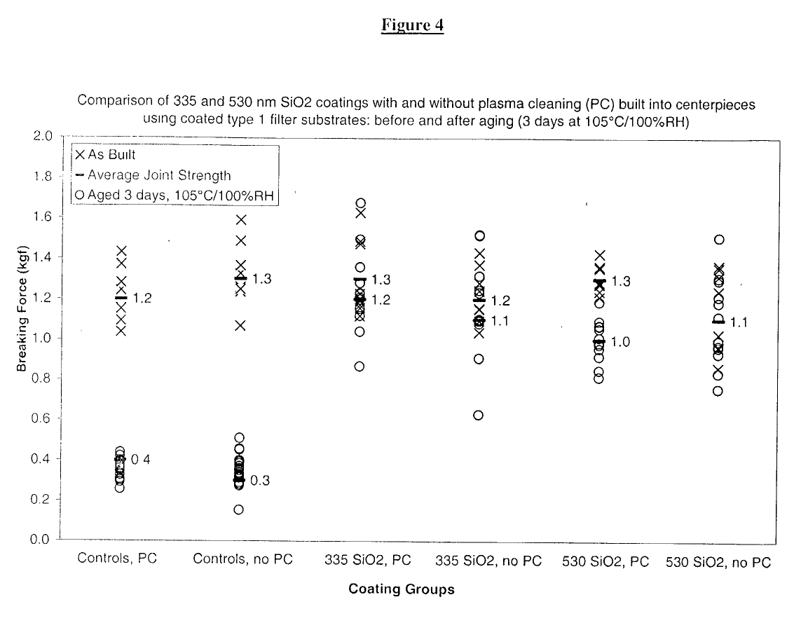

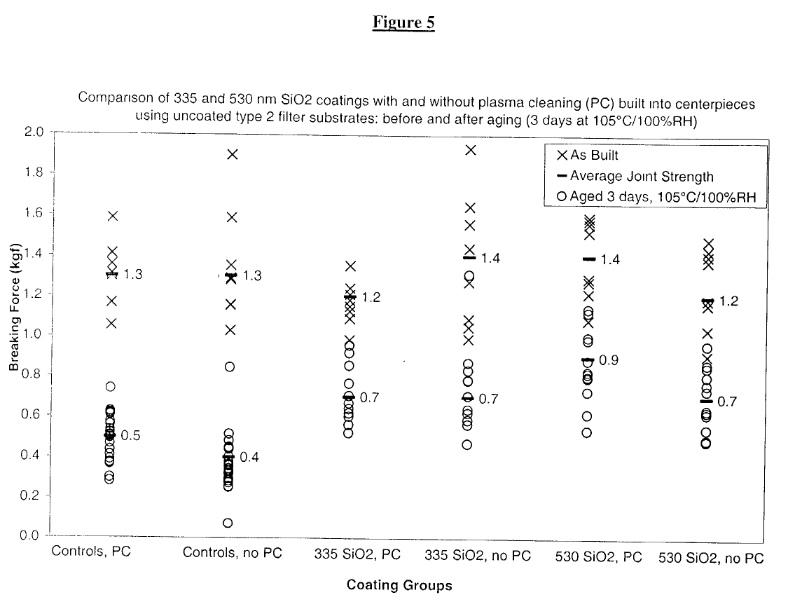

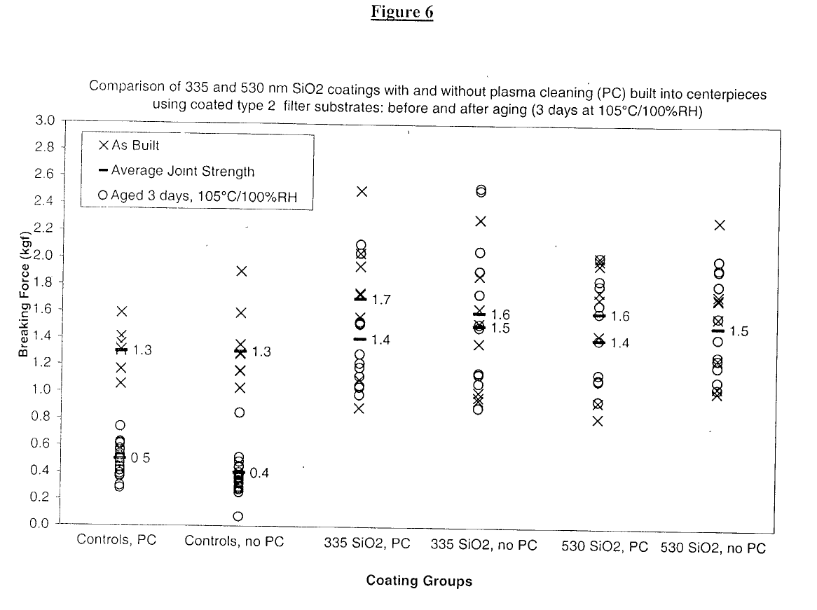

Coating both the type 1 filter substrates and lenses with SiO₂ did not show a significant joint strength difference after aging when compared to coating just the lenses (FIGS. 3 and 4), however for type 2 filter substrates a significant joint strength improvement was observed when these filters were coated in addition to the lenses (FIGS. 5 and 6).

Plasma cleaning of freshly SiO₂-coated lenses generally reduced the variance within the sample groups, but did not improve the average centerpiece joint strength when compared to non-plasma-cleaned counterparts.

Failure analysis of these samples showed the following common trends for aged samples:

The weakest joints examined for a given sample set tended to have greater amounts of adhesive failure on the lenses.

The strongest joints examined for a given sample set tended to have greater amounts of adhesive failure on the filters. Some cohesive failures within the lenses were also observed, as well as coating delamination (either cohesively, or adhesively from the filter and lenses).

Crystal formation was only seen on uncoated lenses and filter substrates.

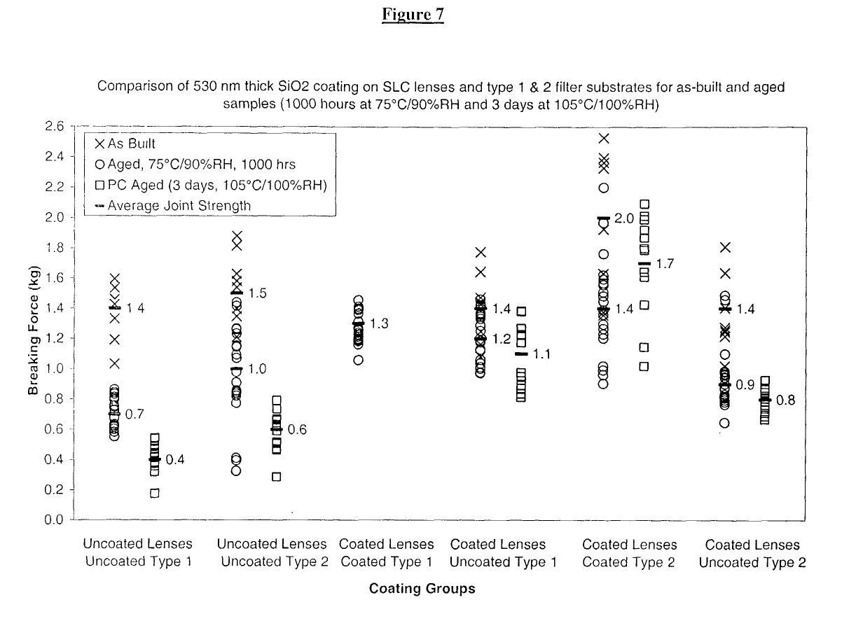

3) Long-term Aging at 75° C./90%RH (FIG. 7)

The objective of this test was to evaluate the efficiency of the SiO₂ coatings (530 nm thick layers) in long-term aging at 75° C./90%RH. The sample groups tested (8 ‘As-built’ and 20 aged centerpieces per group) were:

control group 1: centerpieces built with uncoated SLC lenses and uncoated type 1 filter substrates.

control group 2: centerpieces built with uncoated SLC lenses and uncoated type 2 filter substrates

coated SLC lenses and coated type 1 filter substrates

coated SLC lenses and uncoated type 1 filter substrates

coated SLC lenses and coated type 2 filter substrates

coated SLC lenses and uncoated type 2 filter substrates

Plasma cleaning was used before assembling the centerpieces. Sample groups were built and tested for ‘As-Built’ (non-aged) and aged (3 days at 105° C./100%RH and 1000 hours at 75° C./90%RH).

When analyzing the data for the centerpieces built with type 1 filter substrates, the results in FIG. 7 show that:

SiO₂ coated lenses improved joint strength at least 1.7 times when compared to uncoated lenses when aged for 1000 hours at 75° C./90%RH, and improved joint strength 2.8 times when aged 3 days at 105° C./100%RH.

The 75° C./90%RH aging conditions (1000 hours) did not age the control samples as vigorously as the accelerated aging 3 days at 105° C./100%RH, as determined by the higher joint strength observed for the 75° C./90%RH aging conditions.

The SiO₂ coated lenses (uncoated type 1 filter substrates) showed no statistical difference in joint strength when aged either at 105° C./100%RH (3 days) or in the 75° C./90%RH aging test (1000 hours).

The 75° C./90%RH aging conditions did not show a statistical improvement in joint strength when the type 1 filter substrates were coated in addition to the lenses.

When analyzing the data for the centerpieces built with type 2 filter substrates, results in FIG. 7 show that:

Centerpieces built using SiO₂ coated type 2 filter substrates and lenses showed significant improvements in joint strength when compared to uncoated controls for either aging conditions: 1.4 times joint strength improvement for 75° C./90%RH aging and 2.8 times improvement for 105° C./100%RH aging when compared to uncoated controls.

The 105° C./100%RH results showed a slight significant improvement in joint strength when only the lenses were coated and uncoated type 2 filter substrates were used when compared to uncoated controls.

The 75° C./90%RH aging for 1000 hours did not show a statistical difference between the uncoated controls and the SiO₂ coating on lenses only. This is the only difference observed between the 105° C./100%RH and the 75° C./90%RH aging conditions.

Although the joint strength after aging in 75° C./90%RH conditions for 1000 hours was the same for the uncoated controls and SiO₂ coating only the lenses, the variance was lower and there was a reduction in low-end outliers for the SiO₂ coated group when compared to the uncoated controls.

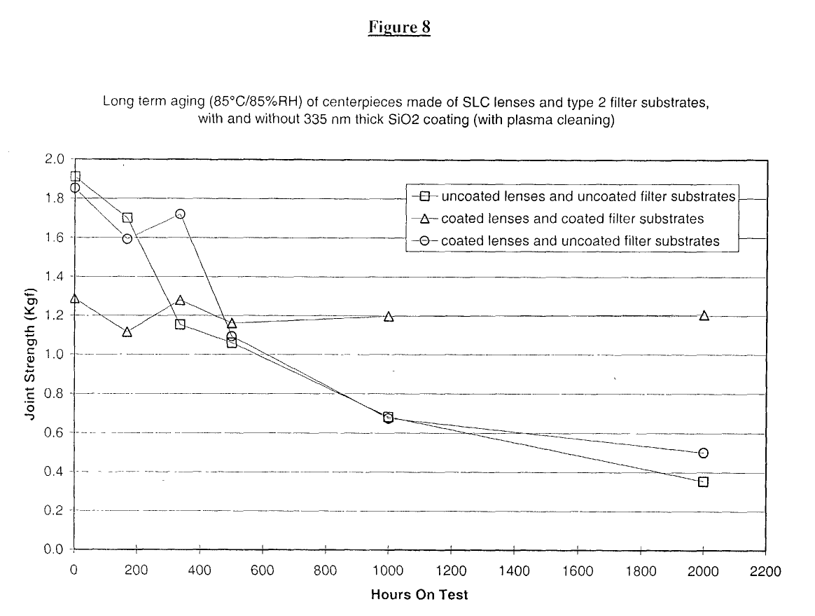

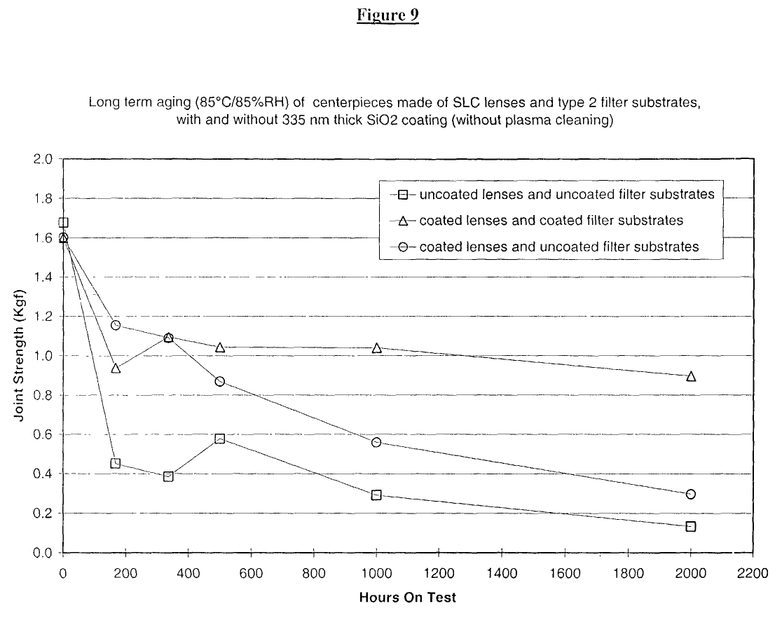

4) Long-term Aging at 85° C./85%RH (FIGS. 8 and 9)

The aim of this test was to determine the effect of long-term aging at 85° C./85%RH on the joint strength of centerpieces constructed using SiO₂ coated lenses, and coated or uncoated filter substrates. The effect of plasma cleaning of the lenses and filter substrates was also assessed. The samples were aged for up to 2000 hours at 85° C./85%RH.

The sample groups consisted of centerpieces built using SLC lenses and type 2 filter substrates (no optical coating). The control groups had no lens or filter substrate coatings. The test groups were constructed using either silicon dioxide coating on both filter substrates and lenses, or silicon dioxide coating on lenses only (no filter substrate coatings). In all cases, a SiO₂ thickness of 335 nm was used.

Centerpieces were built with (FIG. 8) and without (FIG. 9) plasma cleaning the lenses and filter substrates.

From FIGS. 8 and 9 showing joint strength as a function of time, it can be seen that there is an apparent trend showing joint strength maintained at a high level when both filters and lenses are coated. If only the lenses are coated, or if both lenses and filters are uncoated, there appears to be a distinct downward trend in joint strength over time.

Coating the filter substrates with SiO₂ increased the joint strength by approximately an additional 110% over coating only the lenses. Plasma cleaning improved the joint strength of a SiO₂ coated lens centerpiece by the order of 30%.

Conclusions

The coating groups that increased centerpiece joint strength and reduce low-end outliers after aging, when compared to uncoated control groups, are the 4 layer coating and silicon dioxide (SiO₂) coating groups.

While the 4-layer coating consists of alternating layers of Nb₂O₅ and SiO₂, the outermost layer being SiO₂, the joint strength after aging was less than when one layer of SiO₂ was used. The difference in improvement for the centerpieces joint strength can be explained by the failure mode analysis results, which indicate that the silicon dioxide coating had little coating delamination when compared to the 4 layer coating which showed extensive coating delamination before and after aging.

The Al₂O₃ coatings did not show any joint strength improvements. This coating group had extremely poor adhesion between the coating and adhesive, based on the higher incidence of adhesive failures, both for ‘As-Built’ and aged samples, which resulted in low centerpiece joint strength. It was demonstrated that the aluminum oxide (Al₂O₃) coating was an efficient ion-retarding “barrier”, but the adhesion between this coating and the adhesive used in this study would require some improvement.

The best performance for the coatings tested was observed with a single layer silicon dioxide coating of either 335 nm or 530 nm thickness, as based on the centerpiece joint strength, significant reduction of adhesive failures and the absence of crystal formation after aging.

While coating both the lenses and type 1 filter substrates with SiO₂ showed an almost negligible difference in joint strength after aging when compared to coating just the lenses, a significant improvement in joint strength was achieved when the type 2 filters were coated as well as the lenses. This was clearly demonstrated in the long-term aging test at 85° C./85%RH.

Long-term aging, up to 2000 hours at 85° C./85%RH, demonstrated the efficiency of SiO₂ coating to improve centerpiece joint strength. It was demonstrated that coating the lenses with SiO₂ provides some improvement of the aged joint strength over the uncoated controls. Further improvement in joint strength occurs with the addition of SiO₂ coating to the filter substrates.

In all cases, crystal formation was only observed on uncoated lenses and filter substrates.

For short exposures to damp heat conditions (3 days at 105° C./100%RH), the results indicate that plasma cleaning freshly SiO₂ coated lenses had a minimal impact on centerpiece joint strength when compared to like groups that did not undergo plasma cleaning. In almost all of the cases the plasma cleaned groups had a tighter distribution than their non-plasma cleaned counterparts.

For long exposures to damp heat (2000 hours at 85° C./85%RH), plasma cleaning the coated lenses and filter substrates improved the joint strength after aging by around 30%.

1. A method of enhancing adhesion between a component having a glass surface and an adhesive, the surface and the adhesive defining a bonding interface therebetween, the method comprising the step of providing a layer of an ion-migration retarding material between the glass surface and the adhesive, the layer being non-releasably attached to at least the glass surface at the bonding interface.

2. The method of claim 1 wherein the ion-migration retarding material comprises substantially pure silicon dioxide.

3. The method of claim 1 wherein the adhesive is an epoxy adhesive.

4. The method of claim 1 wherein the component comprises a glass containing water-soluble ions that are susceptible to migration when exposed to aqueous environment.

5. The method of claim 1 wherein the retarding material is a multi-layer coating comprising a silicon dioxide layer.

6. The method of claim 1 wherein the Retarding material comprises aluminum oxide.

7. The method of claim 1 wherein the adhesive is a hybrid or inorganic adhesive.

8. The method of claim 7 wherein the adhesive is a solder.

9. The method of claim 1 wherein the step of providing a layer is preceded by plasma cleaning of the glass surface.

10. The method of claim 4 wherein the ion-migration retarding material has mechanical and optical properties compatible with the properties of the component.

11. An adhesive joint between a component having a glass surface and another component or material, the joint comprising an adhesive and a layer of an ion-migration retarding material disposed between the glass surface and the adhesive and non-releasably attached at least to the glass surface.

12. The joint of claim 11 wherein the layer is further non-releasably secured to the adhesive.

13. The joint of claim 11 wherein the adhesive is an epoxy adhesive.

14. The joint of claim 11 wherein the ion-migration retarding material comprises substantially pure silicon dioxide.

15. The joint of claim 11 wherein the retarding material is a multi-layer coating comprising a layer of silicon dioxide.

16. The joint of claim 14 wherein the thickness of the silicon dioxide is of the order of a micron or less.

17. The joint of claim 11 wherein the ion-migration retarding material has mechanical and optical properties compatible with properties of the component.

18. The joint of claim 11 wherein the adhesive is a hybrid or inorganic adhesive.

19. The joint of claim 18 wherein the adhesive is a solder.

20. The joint of claim 11 wherein the retarding material comprises aluminum oxide.

21. A method of inhibiting ion migration and crystal formation at the surface of an ion-doped glass component, the method comprising coating the surface of the component with a layer of silicon dioxide.
